(19) United States
(12) Patent Application Publication
(10) Pub. No.: US 2012/0228864 A1
(43) Pub. Date: Sep. 13, 2012

(54) Offset secondary pivot point

(76) Inventors: Adam Christopher Kerns, Haines, OR (US); James Nathan Kerns, Bremerton, WA (US)

(21) Appl. No.: 12/932,746

(22) Filed: Mar. 7, 2011

(51) Int. Cl. F16L 23/16

(52) U.S. Cl. 285/80

(57) ABSTRACT

The wheel tracks (see FIG. 6) of a self propelled center pivot irrigation system can be moved by using the natural movement of the center pivot. This is accomplished by locking the primary pivot point (see FIG. 1) and unlocking the offset secondary pivot point (see FIGS. 7,8) and allowing the natural movement of a center pivot to rotate the top elbow of the offset secondary pivot point. Once the top elbow of the offset secondary pivot point reaches the desired setting (see FIGS. 7,8) the offset secondary pivot point can be locked and the primary pivot point unlocked. This will allow normal center pivot operation with the drive units (see FIG. 2) running on a new track. (see FIGS. 9,10,11,12)

### BACK GROUND OF THE INVENTION

(1) Field of Invention

This invention relates to agricultural irrigation systems, namely center pivot irrigation systems. Farmers who use center pivot irrigation systems have ordinary skill in this art.

(2) Description of the Related Art

This invention is intended for use on self propelled center pivot systems. It is intended to be useful for the purpose of managing wheel tracks (see FIG. 6), which are a common problem with the use of center pivots.

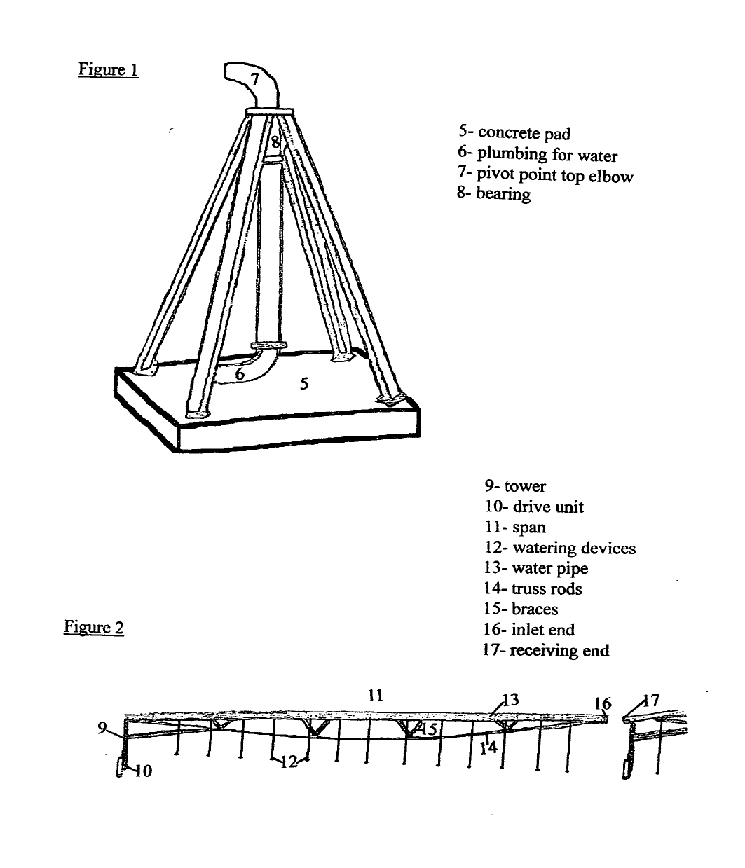

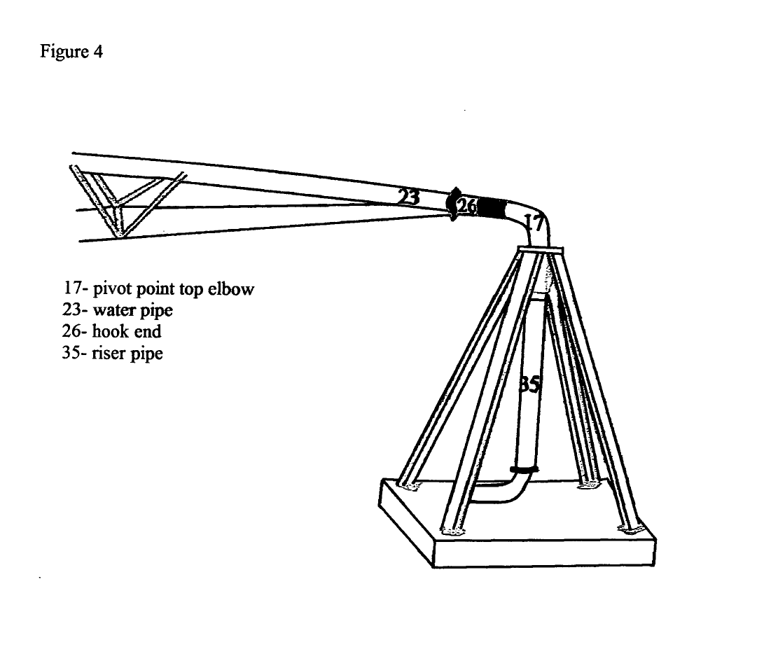

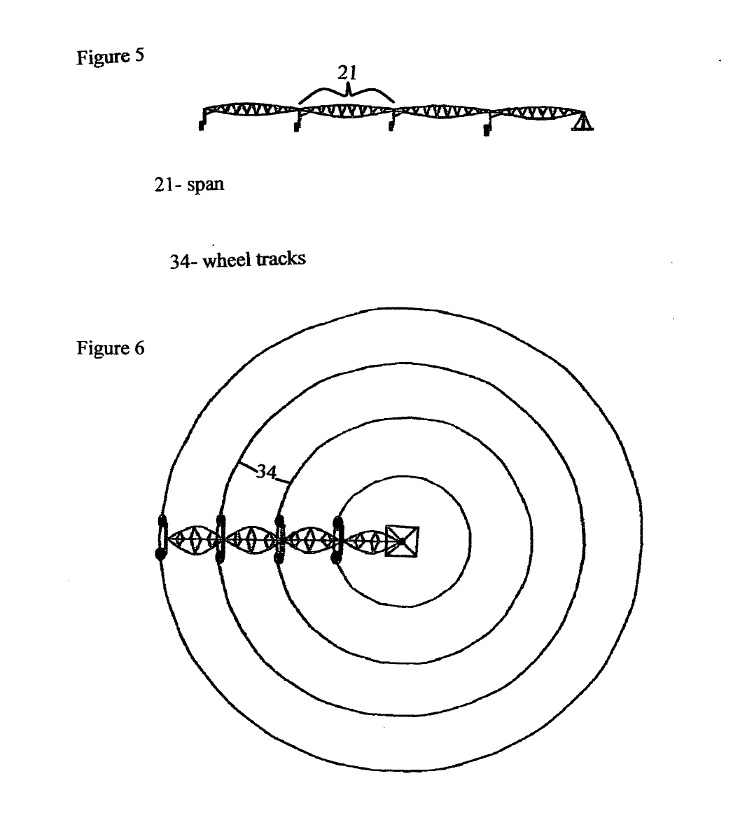

A center pivot is a complex structure comprised of a pivot point (see FIG. 1), spans, towers, and a drive units (see FIG. 2). The pivot point is the anchor at the center of the field. The hook end of the first span hooks to the pivot point (see FIG. 4). The hook end of the second span hooks to the receiver end of the first span (see FIG. 5). This process can be repeated as little or as much as required to obtain the desired length of system. Each span has a linkage between the receiver end and the hook end of the following span. This linkage turns the drive units on and off to maintain span-to-span alignment. The last span on a system moves, all the other spans move as required to maintain alignment. Because the first span is anchored at the center of the field, all the spans move in a circle around the pivot point. (see FIGS. 4,6)

At regular intervals the water pipe on each span (see FIG. 2) has an outlet where a watering device is attached. As the system moves water is pumped down the pipes and is distributed onto the ground beneath the system (see FIG. 2). The result is a heavy structure traveling over soft, wet ground. As the tires on the drive unit continually move across the wet, soft ground the wheel tracks get progressively deeper. (see FIG. 6)

Manufacturers have recognized this problem, and offer a wide range of high flotation tires in an effort to spread the load onto a larger surface area. Many other attempts and products have come onto the market. Bean U.S. Pat. No. 4,059,911 recognized this problem and built a device with plows attached to the drive unit which would plow the soil adjacent to the ruts back into the ruts. Other attempts to combat wheel tracking include the following:

Corsentino U.S. Pat. No. 4,209,068 track closing attachment,

Gillespie U.S. Pat. No. 5,845,717 tractor mounted wheel track closing device

Buhler U.S. Pat. No. 6,427,781 wheel track scraper

Malsam U.S. Pat. No. 6,663,028 wheel track closing assembly

Starr U.S. Pat. No. 6,616,374 wide flat tracks.

Another way wheel tracks have been dealt with is to insert a short extension pipe into the system between the top elbow of the pivot point and the hook end of the first span (see FIG. 4). By inserting an extension pipe in this location all the drive units are moved away from the pivot point at a distance equal to the length of the extension pipe. This procedure has proved to be extremely labor intensive, and is typically a last resort option to get a system out of its deep, impassable ruts.

U.S. Pat. No. 5,435,495 filed by Jimmy R. Davis provided a more convenient method to move the wheel tracks by using a telescoping joint between the pivot point and first span. This method required the use of additional motors and wiring to provide for pull-in and let-out sequences.

### SUMMARY OF THE INVENTION

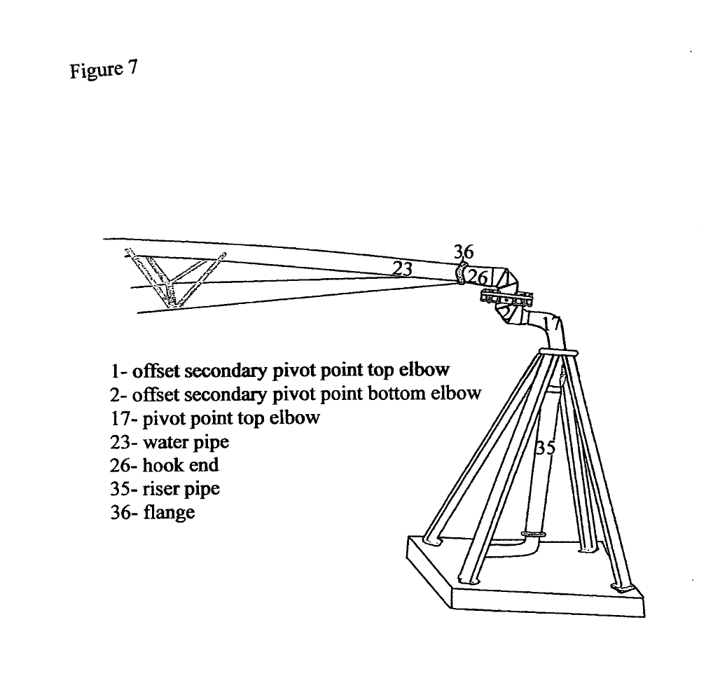

The offset secondary pivot point provides a simple, cost-effective solution to manage wheel tracks on center pivots (see FIG. 6). The offset secondary pivot point is installed between the outlet of the top elbow of the pivot point and the water pipe of the hook end of the first span (see FIGS. 4, 7&8).

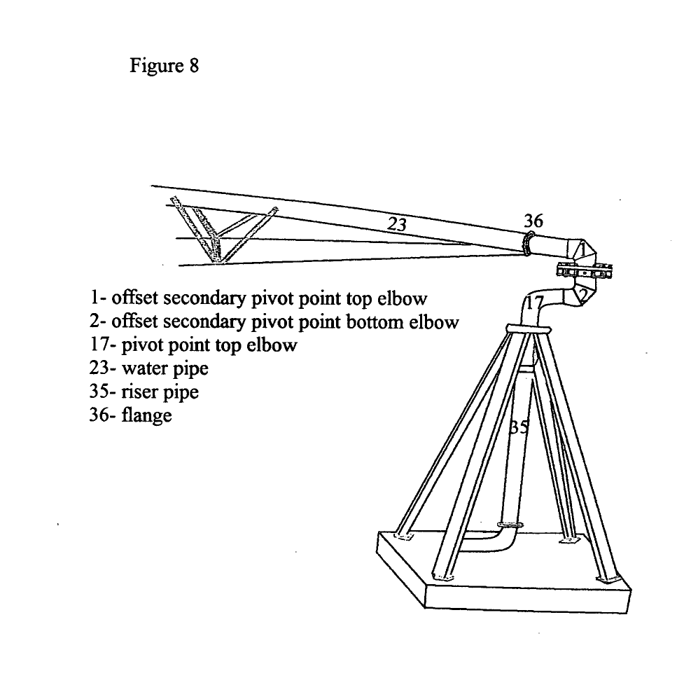

By locking the pivot point and unlocking the offset secondary pivot point the natural movement of the system will provide the pull-in or let-out sequences. (Without the need for additional motors and wiring)(see FIGS. 7&8) The pull-in sequence will cause all drive units on the system to move closer to the pivot point (see FIGS. 8,9 &10). The let-out sequence will cause all drive units on the system to move away from the pivot point (see FIGS. 7,11 & 12).

Once the desired movements is achieved the offset secondary pivot point can be locked to prevent any further pull-in or let-out movement, and the pivot point will be unlocked to allow normal operation of the center pivot with the drive units on a new track.

### Objective of This Invention

The objective of this invention is to provide agricultural producers and municipalities, who work closely with center pivots, a tool to manage the problem of wheel tracks (see FIG. 6). Soils, management, and preferred methods of management change with every location. Some producers may choose to move a wheel track on an annual basis. For another producer, multiple moves each year may be necessary. For an application on pasture, where wheels running over the crop won't hurt production, a manager may chose to move the wheel track at every rotation and use the full range of extension and retraction (see FIGS. 7&8). Whatever the need is, the secondary offset pivot point is built to be a valuable, versatile, and low maintenance tool to manage wheel tracks.

### DESCRIPTION OF DRAWINGS FOR NORMAL CENTER PIVOT OPERATION

To best understand my invention it is necessary to have a basic understanding of the normal operations of a self propelled center pivot irrigation system, (most commonly called a center pivot). Those who work closely with the agricultural industry will recognize the following drawings and descriptions as general knowledge. FIGS. 1-6 show typical center pivot operation.

### FIG. 1 Pivot Point

The pivot point is the only stationary structure on a self propelled center pivot irrigation system. The structure is bolted to a concrete pad and provides the plumbing to get water into the pipe of the first span. Each pivot point has a top elbow which can rotate a full 360 degrees while still maintain a water-tight seal. Each pivot point also has a bearing to support the elbow and the forces exerted upon it during the normal operations of the center pivot.

### FIG. 2 Span

A span is a structure comprised of water pipe, truss rods, braces, a tower, and a drive unit. A span is one section of a center pivot. Spans can be various lengths, and multiple spans can be hooked onto a system to obtain the desired length for a center pivot. The hook end of the first span hooks to the top elbow of the pivot point (see FIG. 4).

The hook end of the second span hooks to the receiving end of the first span. This is repeated until the desired length of system is achieved.

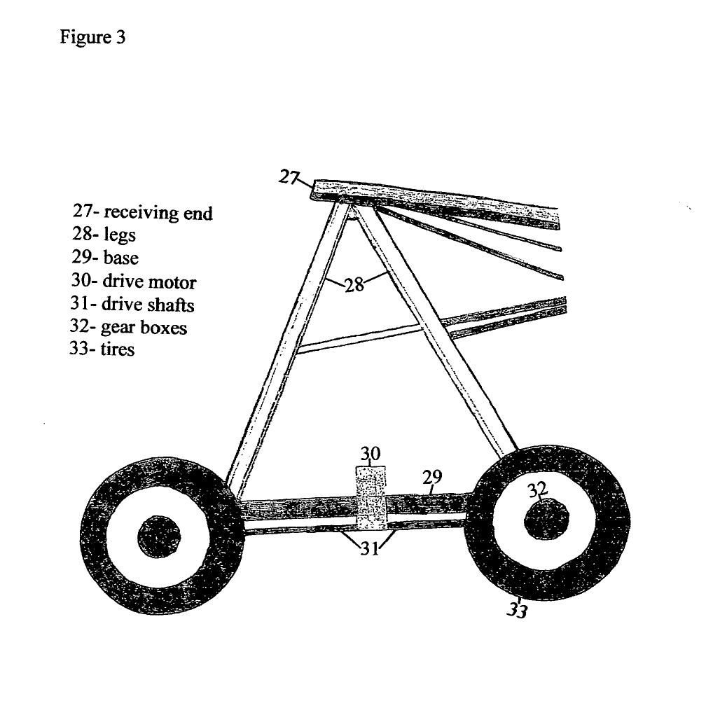

### FIG. 3 Tower

Each span has a tower on the receiver end. The tower has legs and a tower base that holds the drive unit. The drive unit consists of a drive motor, drive shafts, gear boxes, and tires. The drive unit operates by turning on and off as necessary to keep all towers on the system in line with each other.

### FIG. 4

This figure shows where the hook end of the first span, hooks to the top elbow of the pivot point.

### FIG. 5 (Side View)

This figure shows how multiple spans are hooked together to make the desired length of a system.

### FIG. 6 (Over Head View)

This figure shows how the spans walk a circle around the stationary pivot point. The circles represent the wheel tracks made by normal operation of a center pivot.

### DESCRIPTIONS OF DRAWINGS FOR OFFSET SECONDARY PIVOT POINT

### FIG. 7

Figure seven shows the offset secondary pivot point installed between the outlet of the top elbow of the pivot point, and the hook end of the first span. Figure seven shows how the offset secondary pivot point will look in its fully extended position. Note the distance between the riser pipe center line and the flange location on the hook end of the first span.

### FIG. 8

Figure eight shows the offset secondary pivot point installed as shown in figure seven except the offset secondary pivot point has been rotated into the fully retracted position. There are also positions between extended (FIG. 7) and retracted (FIG. 8) but for the purpose of describing the concept only extended (FIG. 7) and retracted (FIG. 8) positions are shown. Note in the retracted drawing (FIG. 8) the riser pipe center line and the flange location on the hook end of the first span are now aligned

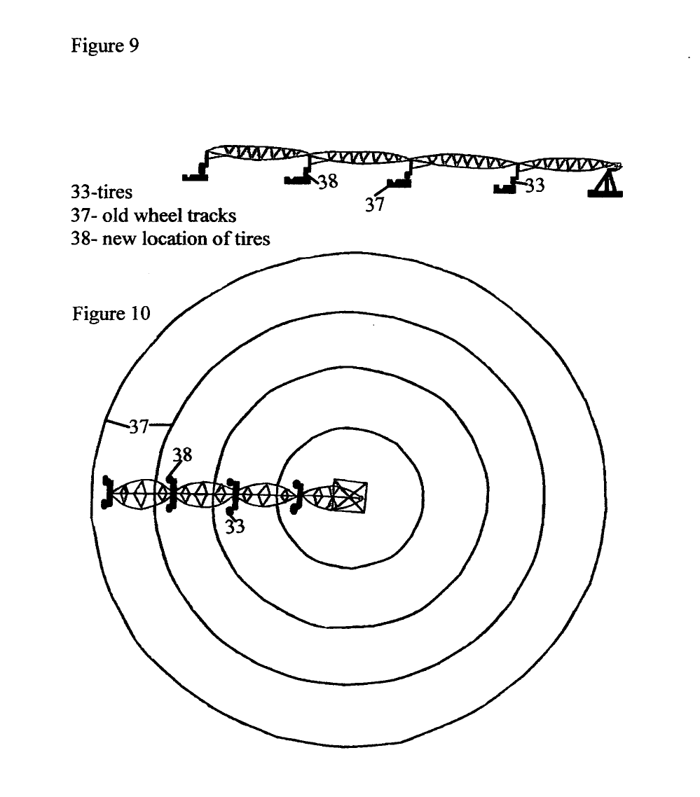

### FIG. 9

Figure nine shows a side view of a center pivot with a retracted offset secondary pivot point. Note the location of the old wheel tracks in relation to where the tires are now running.

### FIG. 10

Figure ten shows an overhead view of a center pivot with retracted offset secondary pivot point. The circles represent the old wheel tracks of a system running without an offset secondary pivot point. Note the new location of the tires in relation to the old wheel tracks.

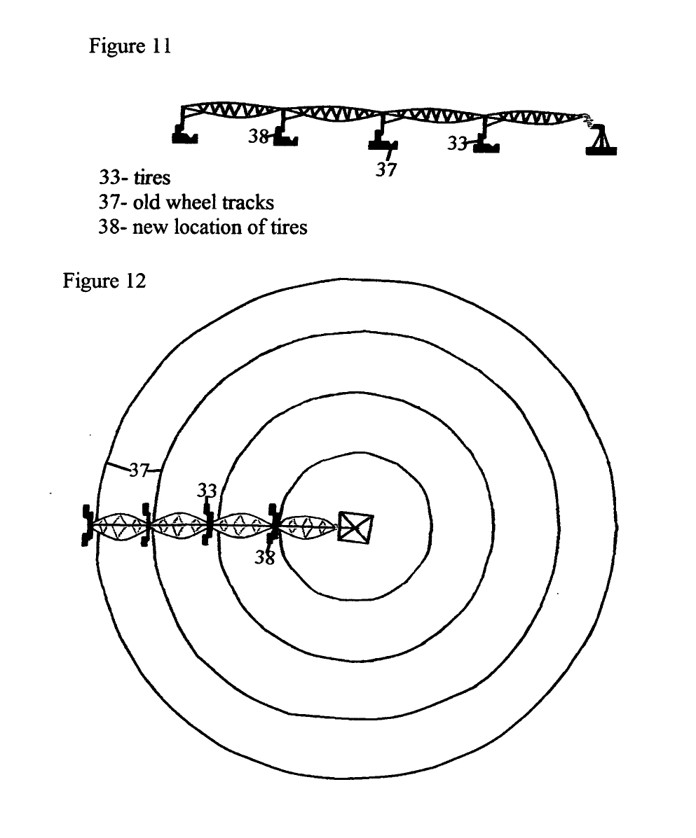

### FIG. 11

Figure eleven shows side view of a center pivot with an extended offset secondary pivot point. Note the location of the old wheel tracks in relation to where the tires are now running.

### FIG. 12

Figure twelve shows an over head view of a center pivot with an extended offset secondary pivot point. The circles represent the old wheel tracks of a system running without an offset secondary pivot point. Note the new location of the tires in relations to the old wheel tracks.

### Offset Secondary Pivot Point Assembly

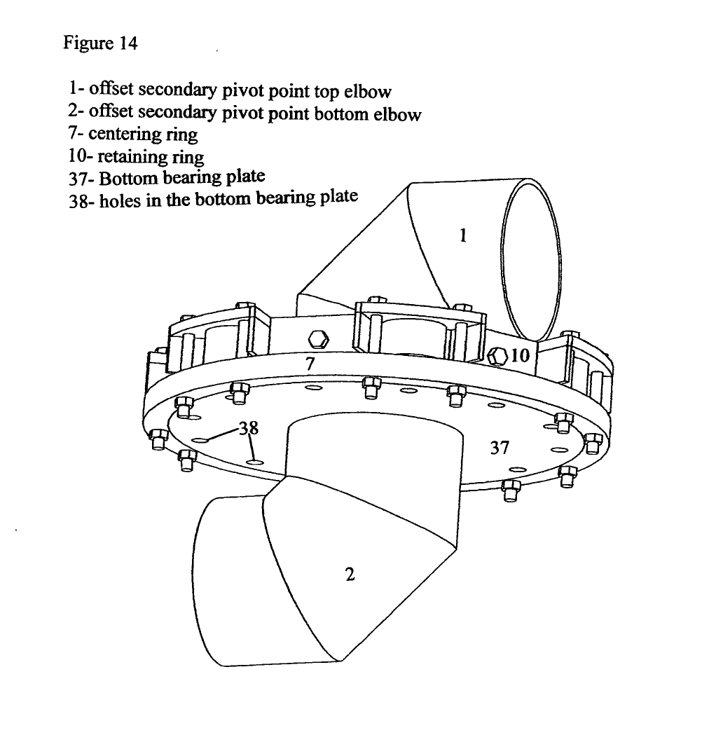

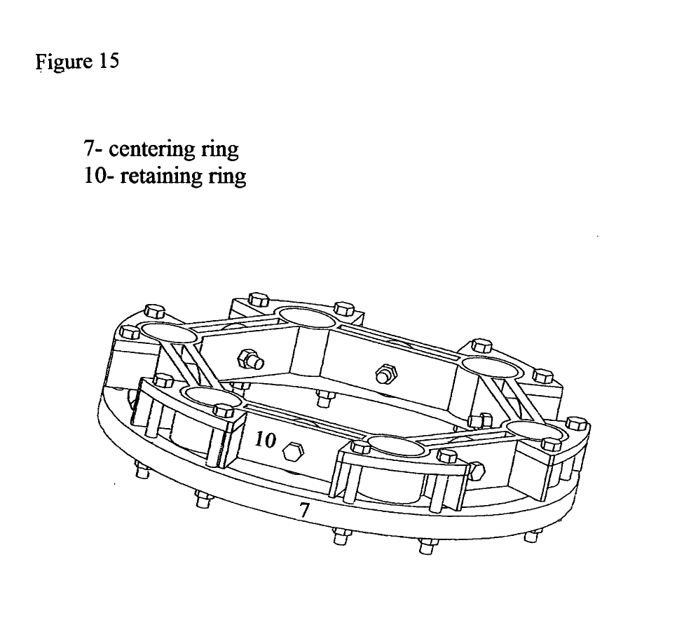

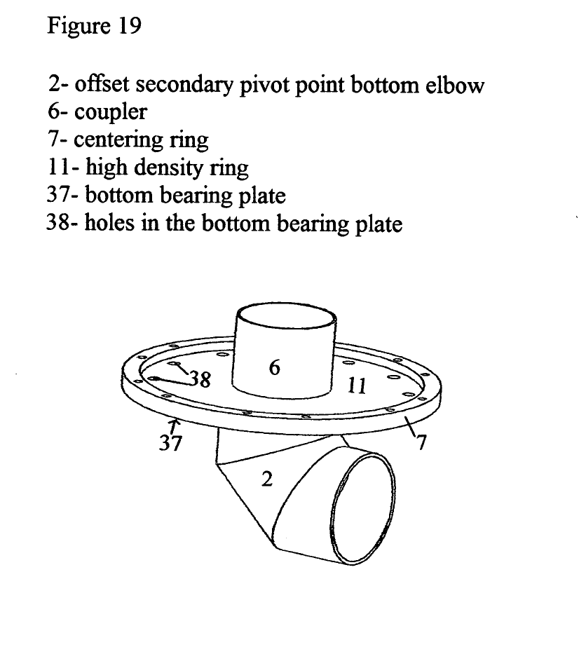

The bottom elbow is welded onto the bottom bearing plate (see FIG. 19). A hole is cut in the center of the bottom bearing plate. The coupler is welded to the bottom bearing plate on the opposite side from the bottom elbow (see FIG. 19). The centering ring is welded to the perimeter of the bottom bearing plate in such a way that the top bearing plate will have to set inside the centering ring when assembled onto the bottom bearing plate. (See FIGS. 14, 16, and 19)

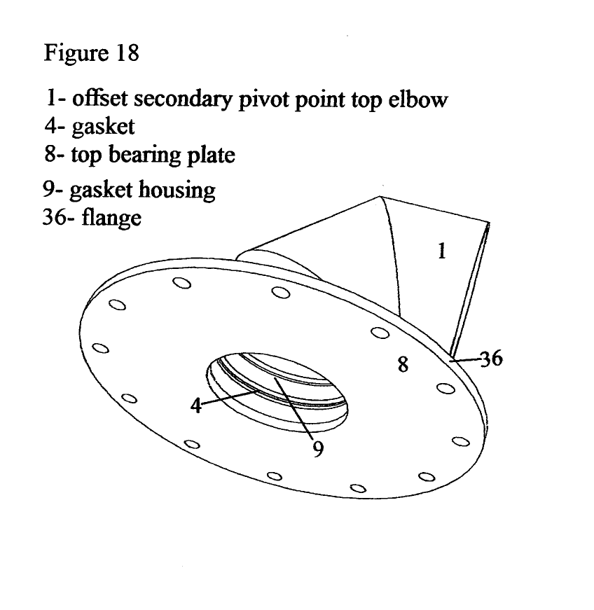

A gasket housing is welded to the top bearing plate. A hole is cut in the top bearing plate to allow the coupler to pass through the top bearing plate and extends into the gasket housing. (See FIGS. 18, 19)

The top elbow is mated over the gasket housing and welded to the top bearing plate. (See FIG. 18)

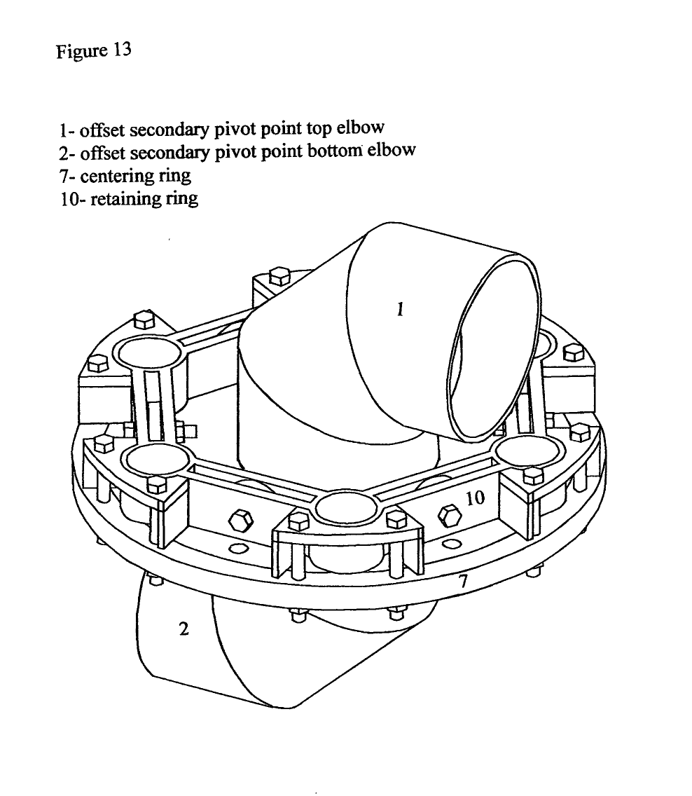

The retaining ring is installed over the top elbow and is bolted to the centering ring. The bottom elbow, bottom bearing plate, centering ring, retaining ring, and coupler all remain stationary (see FIGS. 13 & 19). The top bearing plate and top elbow are able to rotate within the centering ring, and the gasket in the gasket housing provides a water-tight seal. (See FIGS. 14 and 18)

Holes in the perimeter of the top and bottom bearing plates allow the offset secondary pivot point to be bolted together (see FIG. 18). This locks the position of the top elbow in relation to the bottom elbow. (See FIGS. 14 &16)

A high density plastic ring is installed between the top and bottom bearing plates for smooth operation (see FIG. 19).

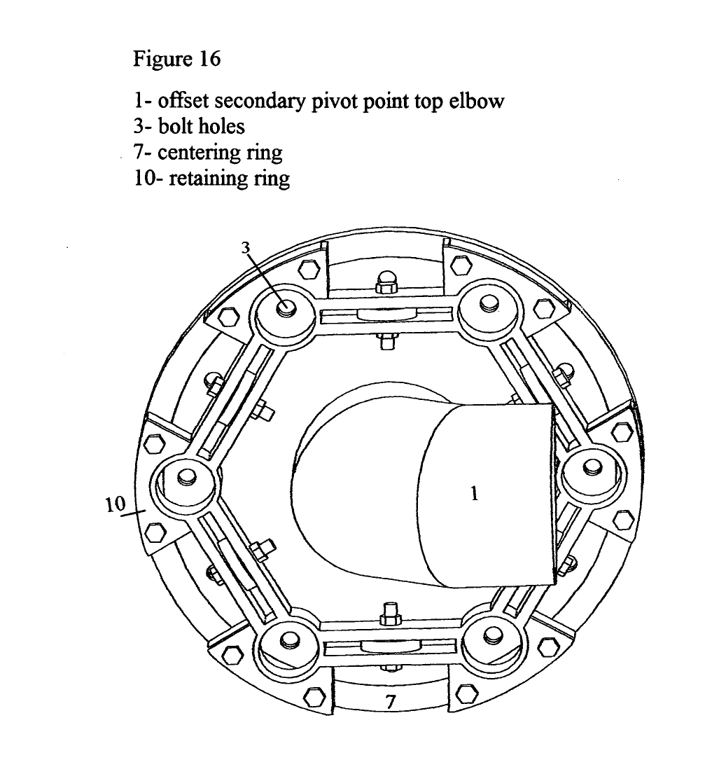

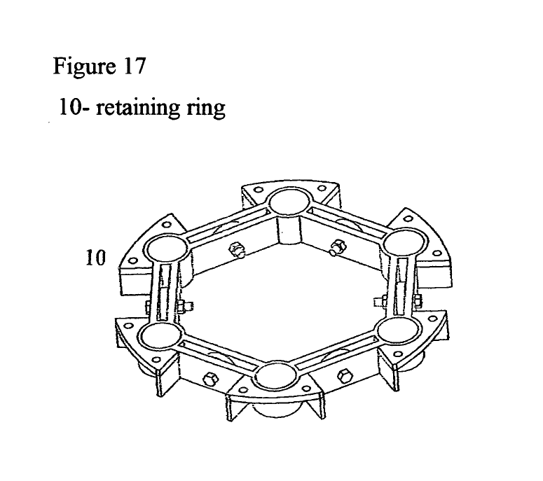

1. I claim as my invention an offset secondary pivot point:
A. That is attached between the receiving end of the top elbow of the primary pivot point and the hook end of the first span, (see FIG. 7)
B. that contains a bearing assembly able to handle all lateral, vertical, and radial forces, exerted by normal operation of a self propelled center pivot irrigation system, (see FIG. 18)
C. that has a top elbow which is able to rotate independent from the bottom elbow when the offset secondary pivot point is unlocked, (see FIG. 13)
D. that has a seal (see FIG. 18) that prevents water leakage at all times during normal center pivot operation as well as during pull-in or let-out operations,
E. that has bolt holes to lock the desired angle of operation for the elbows, (see FIG. 16)
F. that allows for the normal movement of a self propelled center pivot irrigation system to provide the pull-in or let-out sequences by locking the primary pivot point and unlocking the offset secondary pivot point, (see FIGS. 7,8)
G. that allows the self propelled center pivot irrigation system to resume normal operation in a new track when the offset secondary pivot point is locked and the primary pivot point is unlocked. (see FIGS. 7-12)
